(19) United States
(12) Patent Application Publication
(10) Pub. No.: US 2010/0006005 A1
(43) Pub. Date: Jan. 14, 2010

(54) Coating materials containing silane-modified nanoparticles

(76) Inventors: Norbert Roesch, Gersthofen (DE); Ernst Krendlinger, Friedberg (DE); Anja Heinze, Meitingen/Erlingen (DE); Karl Zeisberger, Gersthofen (DE)

Correspondence Address: CLARIANT CORPORATION;INTELLECTUAL PROPERTY DEPARTMENT, 4000 MONROE ROAD, CHARLOTTE, NC, 28205, US

(21) Appl. No.: 11/990,357

(22) PCT Filed: Aug. 16, 2006
(86) PCT No.: PCT/EP2006/008065

§ 371 Date: Jul. 9, 2009

(30) Foreign Application Priority Data
Aug. 18, 2005 (DE) 10 2005 039 436.1

(51) Int. Cl. C09D 1/00

(52) U.S. Cl. 106/287.1

(57) ABSTRACT

The invention relates to coating materials containing silane-modified nanoparticles an organic binder and possibly additives, wherein the coating materials contain silane-modified nanoparticles which are obtainable by disaggregating agglomerates containing the particles in the presence of an organic solvent and simultaneous or afterwardly carrying out a silane treatment. Thus the silane-modified nanoparticles provide the coating materials and coatings with an improved scratch resistance.

Coating materials containing silane-modified nanoparticles Known are nanoparticle-comprising coating materials, the nanoparticles being prepared by means of sol-gel technology, by hydrolytic (co)condensation of tetraethoxysilane (TEOS) with further metal alkoxides in the absence of organic and/or inorganic binders. From DE 199 24 644 it is known that the sol-gel synthesis can also be carried out in the medium. Preference is given to using radiation-curing formulations. All materials prepared by means of sol-gel operation, however, are distinguished by low solids contents in terms of organic and inorganic solid, by increased amounts of the condensation product (generally alcohols), by the presence of water, and by limited storage stability.

A step forward is represented by the high-temperature-resistant, reactive metal oxide particles prepared by hydrolytic condensation of metal alkoxides on the surface of nanoscale inorganic particles in the presence of reactive binders. The temperature resistance of the fully reacted formulations is achieved through the heterogeneous copolymerization of reactive groups of the medium with reactive groups of the binder that are of the same kind. A disadvantage here is the incompleteness of the heterogeneous copolymerization, in which not all of the reactive groups on the surface of the particles take part in the copolymerization. Steric hindrances are the primary reason. As is known, however, the groups which have not fully reacted lead to unwanted secondary reactions, which may give rise to discoloration, embrittlement or premature degradation. This is true particularly for high-temperature applications. Even the process described in DE 19846 660 leads to systems which are not stable on storage, owing to the acidic medium in the presence of the condensation product (generally alcohols).

Also known are nanoscale surface-modified particles (Degussa Aerosil® R 7200) formed by condensation of metal oxides with silanes in the absence of a binder and hence in the absence of strong shearing forces of the kind which act in viscous media at stirring speeds of ≧10 m/s. For this reason these aerosils possess larger particles than the raw materials employed; their opacity is much higher and their activity is lower than the action of the particles described in WO 00/22052 and of the varnishes produced from them.

It is an object of the invention to eliminate the disadvantages of the prior art and to provide storage-stable and property-stable coating compositions which comprise specially prepared nanoscale inorganic particles.

The invention provides coating compositions comprising silane-modified nanoparticles and an organic binder and also, where appropriate, adjuvants, the coating composition comprising silane-modified nanoparticles obtained by deagglomeration of nanoparticle-comprising agglomerates in the presence of an organic solvent and simultaneous or subsequent treatment with a silane.

Preferred nanoparticles used in accordance with the invention are particles having an average size in the range from 1 nm to 200 nm, preferably 1 to 100 nm, and are composed of oxides of elements from main group 3, more particularly aluminum.

These nanoparticles are prepared by deagglomeration of larger agglomerates which comprise or consist of these nanoparticles, in the presence of an organic solvent, and simultaneous or subsequent treatment with a silane. Agglomerates of this kind are known per se and can be prepared, for example, by the processes described below.

By chemical syntheses, which are usually precipitation reactions (hydroxide precipitation, hydrolysis of organometallic compounds) with subsequent calcination. In this case crystallization nuclei are frequently added in order to lower the temperature of conversion to the α-aluminum oxide. The sols obtained in this way are dried and in the process converted to a gel. The further calcination then takes place at temperatures between 350° C. and 650° C. For the conversion to the α-Al₂O₃ it is then necessary to carry out calcination at temperatures around 1000° C. The processes are described comprehensively in DE 199 22 492.

A further route to obtaining nanomaterials is the aerosol process. In this case the desired molecules are obtained from chemical reactions of a precursor gas or by rapid cooling with a supersaturated gas. The particles are formed either by collision or the continual vaporization and condensation—which are in equilibrium—of clusters of molecules. The newly formed particles grow through further collision with product molecules (condensation) and/or particles (coagulation). If the rate of coagulation is greater than that of new formation or of growth, agglomerates of spherical primary particles are formed.

Flame reactors represent one preparation variant based on this principle. In this case the nanoparticles are formed by the decomposition of precursor molecules in the flame at 1500° C.-2500° C. Examples include the oxidations of TiCl₄; SiCl₄ and Si₂O(CH₃)₆ in methane/O₂ flames, leading to TiO₂ and SiO₂ particles. Use of AlCl₃ has to date produced only the corresponding alumina. Flame reactors are presently used industrially for the synthesis of submicroparticles such as carbon black, pigmentary TiO₂, silica, and alumina.

Small particles can also be formed from droplets by means of centrifugal force, compressed air, sound, ultrasound, and other methods. The droplets are then converted to powder by direct pyrolysis or by reactions in situ with other gases. Known processes include spray drying and freeze drying. In the case of spray pyrolysis, precursor droplets are transported through a high-temperature field (flame, oven), leading to rapid vaporization of the volatile component or initiating the decomposition reaction to give the desired product. The desired particles are collected in filters. An example of this is the preparation of BaTiO₃ from an aqueous solution of barium acetate and titanium lactate.

Grinding can likewise be used to attempt to comminute corundum and, in so doing, to produce crystallites in the nano range. The best grinding results can be obtained by wet grinding with stirred ball mills. In that case it is necessary to use grinding beads made of material harder than corundum.

Another route to the preparation of corundum at low temperature is the conversion of aluminum chlorohydrate. For this purpose the chlorohydrate is likewise admixed with seed nuclei, preferably of ultrafine corundum or hematite. To avoid crystal growth, the samples must be calcined at temperatures from around 700° C. up to a maximum of 900° C. The duration of calcination is described in this case as being at least four hours. Recently, however, it has been found that, with this process, calcination for a time of 0.5 to 10 minutes is entirely sufficient to prepare nanocrystalline corundum. The method, which is preferred in the context of the present invention, has been comprehensively described in Ber. DKG 74 (1997) no. 11/12, pp. 719-722.

The procedure specifically with this preferred mode of preparation of nanocorundum is as follows:

The starting point is aluminum chlorohydrate, which has the formula Al₂(OH)ₓCl_{y}, where x is a number from 2.5 to 5.5 and y is a number from 3.5 and 0.5, and the sum of x and y is always 6. This aluminum chlorohydrate is mixed as an aqueous solution with crystallization nuclei, then dried and subsequently subjected to a thermal treatment (calcination). It is preferred in this case to start from 50% strength aqueous solutions of the kind available commercially. A solution of this kind is admixed with crystallization nuclei which promote the formation of the α modification of Al₂O₃. More particularly such nuclei bring about a reduction in the temperature for the formation of the a modification in the course of the subsequent thermal treatment. Suitable nuclei include ultrafinely disperse corundum, diaspore or hematite. It is preferred to take ultrafinely disperse α-Al₂O₃ nuclei having an average particle size of less than 0.1 μm. Generally 2% to 3% by weight of nuclei is enough, based on the aluminum oxide formed.

This starting solution may further comprise oxide formers. Particularly suitable in this respect are chlorides, oxychlorides and/or hydrochlorides of the elements from main groups II to V and also from the transition groups, more particularly the chlorides, oxychlorides and/or hydrochlorides of the elements Ca, Mg, Y, Ti, Zr, Cr, Fe, Co and Si.

This suspension of aluminum chlorohydrate, nuclei, and, where appropriate, oxide formers is then evaporated to dryness and subjected to a thermal treatment (calcination). This calcination takes place in apparatus suitable for the purpose, as for example in push-through, chamber, tube, rotary tube or microwave furnaces or in a fluidized-bed reactor. In one variant of the process of the invention it is also possible to inject the aqueous suspension of aluminum chlorohydrate and nuclei into the calcination apparatus directly, without removing the water beforehand.

The temperature for the calcination ought not to exceed 1100° C. The lower temperature limit is dependent on the desired yield of nanocrystalline corundum, on the desired residual chlorine content, and on the amount of nuclei. The formation of corundum is commenced at as low as about 500° C.; however, in order to keep the chlorine content low and the yield of nanocrystalline corundum high, it is preferred to operate at 700 to 1100° C., more particularly at 1000 to 1100° C.

It has emerged that for the calcination generally 0.5 to 30 minutes, preferably 0.5 to 10, more particularly 0.5 to 5 minutes are sufficient. Even after this short time it is possible to achieve a sufficient yield of nanocrystalline corundum under the conditions stated above for the preferred temperatures. Alternatively, in accordance with the information in Ber. DKG 74 (1997) no. 11/12, p. 722 it is possible to carry out calcination for 4 hours at 700° C. or for 8 hours at 500° C. The calcination produces agglomerates of nanocrystalline corundum in the form of virtually spherical nanoparticles.

From these agglomerates, which comprise or consist entirely of the desired nanoparticles in the form of crystallites, it is necessary to liberate the nanoparticles. This is accomplished preferably by grinding or by treatment with ultrasound.

For the inventive modification of these nanoparticles with silanes there are two options. According to the first variant, the deagglomeration can be performed in the presence of the silane: for example, by adding the silane to the mill during grinding. The second option is first to disintegrate the nanocorundum agglomerates and then to treat the nanoparticles, preferably in the form of a suspension in an organic solvent, with the silane.

Suitable silanes in this context are preferably the following types:

a) R[—Si(R′R″)—O—]ₙSi(R′R″)—R′″ or cyclo-[-Si(R′R″)—O—]ᵣSi(R′R″)—O—

in which

R, R′, R″, R′″, identically or differently from one another, are each an alkyl radical having 1-18 C atoms or a phenyl radical or an alkylphenyl or a phenylalkyl radical having 6-18 C atoms or a radical of the general formula —(CₘH₂ₘ—O)ₚ—C_{q}H_{2q+1} or a radical of the general formula —CₛH₂ₛY or a radical of the general formula —XZₜ₋₁,
n is an integer having a definition 1≦n≦1000, preferably 1≦n≦100,
m is an integer 0≦m≦12 and
p is an integer 0≦p≦60 and
q is an integer 0≦q≦40 and
r is an integer 2≦r≦10 and
s is an integer 0≦s≦18, and
Y is a reactive group, examples being α,β-ethylenically unsaturated groups, such as (meth)acryloyl, vinyl or allyl groups, amino, amido, ureido, hydroxyl, epoxy, isocyanato, mercapto, sulfonyl, phosphonyl, trialkoxysilyl, alkyldialkoxysilyl, dialkylmonoalkoxysilyl, anhydride and/or carboxyl groups, imido, imino, sulfite, sulfate, sulfonate, phosphine, phosphite, phosphate, phosphonate groups, and
X is a t-functional oligomer with
t being an integer 2≦t≦8, and
Z is in turn a radical
   R[—Si(R′R″)—O—]ₙSi(R′R″)—R′″ or cyclo-[-Si(R′R″)—O—]ᵣSi(R′R″)—O—

as defined above.

The t-functional oligomer X is preferably selected from the following: oligoether, oligoester, oligoamide, oligourethane, oligourea, oligoolefin, oligovinyl halide, oligovinylidene dihalide, oligoimine, oligovinyl alcohol, ester, acetal or ether of oligovinyl alcohol, cooligomers of maleic anhydride, oligomers of (meth)acrylic acid, oligomers of (meth)acrylic esters, oligomers of (meth)acrylamides, oligomers of (meth)acrylimides, oligomers of (meth)acrylonitrile, with particular preference oligoethers, oligoesters, oligourethanes.

Examples of radicals of oligoethers are compounds of the type —(CₐH₂ₐ—O)_{b}—CₐH₂ₐ— or O—(CₐH₂ₐ—O)_{b}—CₐH₂ₐ—O with 2≦a≦12 and 1≦b≦60, e.g., a diethylene glycol, triethylene glycol or tetraethylene glycol radical, a dipropylene glycol, tripropylene glycol or tetrapropylene glycol radical or a dibutylene glycol, tributylene glycol or tetrabutylene glycol radical. Examples of radicals of oligoesters are compounds of the type —C_{b}H_{2b}—(O(CO)CₐH₂ₐ—(CO)O—C_{b}H_{2b}—)_{c}— or —O—C_{b}H_{2b}—(O(CO)CₐH₂ₐ—(CO)O—C_{b}H_{2b}—)_{c}—O— with a and b, differently or identically, 3≦a≦12, 3≦b≦12, and 1≦c≦30, e.g., an oligoester of hexanediol and adipic acid.

b) Organosilanes of the type (RO)₃Si(CH₂)ₘ—R′

R=alkyl, such as methyl, ethyl, propyl

m=0.1-20

R′=methyl, phenyl,
—C₄F₉; OCF₂—CHF—CF₃, —C₆F₁₃, —O—CF₂—CHF₂
—NH₂, —N₃, —SCN, —CH═CH₂, —NH—CH₂—CH₂—NH₂,
—N—(CH₂—CH₂—NH₂)₂
—OOC(CH₃)C═CH₂
—OCH₂—CH(O)CH₂
—NH—CO—N—CO—(CH₂)₅
—NH—COO—CH₃, —NH—COO—CH₂—CH₃, —NH—(CH₂)₃Si(OR)₃
—S_{X}—(CH₂)₃)Si(OR)₃
—SH
—NR′R″R′″ (R′=alkyl, phenyl; R″=alkyl, phenyl; R′″═H, alkyl, phenyl, benzyl,
C₂H₄NR″″R′″″ with R″″=A, alkyl and R′″″═H, alkyl).

Examples of silanes of the type defined above are, for example, hexamethyldisiloxane, octamethyltrisiloxane, further homologous and isomeric compounds of the series SiₙOₙ₋₁(CH₃)₂ₙ₊₂, where
n is an integer 2≦n≦1000, e.g., Polydimethylsiloxane 200® fluid (20 cSt).

Hexamethylcyclotrisiloxane, octamethylcyclotetrasiloxane, further homologous and isomeric compounds of the series (Si—O)ᵣ(CH₃)₂ᵣ, where
r is an integer 3≦r≦12,

dihydroxytetramethyldisiloxane, dihydroxyhexamethyltrisiloxane, dihydroxyoctamethyltetrasiloxane, further homologous and isomeric compounds of the series

HO—[(Si—O)ₙ(CH₃)₂ₙ]—Si(CH₃)₂—OH, or

HO—[(Si—O)ₙ(CH₃)₂ₙ]—[Si—O)ₘ(C₆H₅)₂ₘ]—Si(CH₃)₂—OH, where
m is an integer 2≦m≦1000,

preference being given to the α,ω-dihydroxypolysiloxanes, e.g., poly-dimethylsiloxane (OH end groups, 90-150 cST) or polydimethylsiloxane-co-diphenylsiloxane (dihydroxy end groups, 60 cST).

Dihydrohexamethyltrisiloxane, dihydrooctamethyltetrasiloxane, and further homologous and isomeric compounds of the series H—[(Si—O)ₙ(CH₃)₂ₙ]—Si(CH₃)₂—H, where
n is an integer 2≦n≦1000, preference being given to the α,ω-dihydroxypolysiloxanes, e.g., polydimethylsiloxane (hydride end groups, Mₙ=580).

Di(hydroxypropyl)hexamethyltrisiloxane, di(hydroxypropyl)octamethyltetrasiloxane, and further homologous and isomeric compounds of the series HO—(CH₂)ᵤ[(Si—O)ₙ(CH₃)₂ₙ]—Si(CH₃)₂(CH₂)ᵤ—OH, preference being given to the α,ω-dicarbinol polysiloxanes where 3≦u≦18, 3≦n≦1000, or their polyether-modified successor compounds based on ethylene oxide (EO) and propylene oxide (PO), as homo polymer or copolymer HO-(EO/PO)ᵥ-(CH₂)ᵤ[(Si—O)ₜ(CH₃)₂ₜ]—Si(CH₃)₂(CH₂)ᵤ—(EO/PO)ᵥ-OH, preference being given to α,ω-di(carbinol polyether) polysiloxanes with 3≦n≦1000, 3≦u≦18, 1≦v≦50.

Instead of α,ω-OH groups the corresponding difunctional compounds with epoxy, isocyanato, vinyl, allyl, and di(meth)acryloyl groups are likewise employed, e.g., polydimethylsiloxane with vinyl end groups (850-1150 cST) or TEGORAD 2500 from Tego Chemie Service.

Also suitable are the esterification products of ethoxylated/propoxylated trisiloxanes and higher siloxanes with acrylic acid copolymers and/or maleic acid copolymers as modifying compound, e.g., BYK Silclean 3700 from Byk Chemie or TEGO® Protect 5001 from Tego Chemie Service GmbH.

Instead of α,ω-OH groups the corresponding difunctional compounds with —NHR″″ with R″″═H or alkyl are likewise employed, examples being the common-knowledge aminosilicone oils from the companies Wacker, Dow Corning, Bayer, Rhodia, etc., which on their polymer chain carry (cyclo)alkylamino groups or (cyclo)alkylimino groups distributed randomly on the polysiloxane chain.

Organosilanes of type (RO)₃Si(CₙH₂ₙ₊₁) and (RO)₃Si(CₙH₂ₙ₊₁), where
R is an alkyl, such as methyl, ethyl, n-propyl, isopropyl, butyl,
n is 1 to 20.

Organosilanes of type R′ₓ(RO)_{y}Si(CₙH₂ₙ₊₁) and (RO)₃Si(CₙH₂ₙ₊₁), where
R is an alkyl, such as methyl, ethyl, n-propyl, isopropyl, butyl,
R′ is an alkyl, such as methyl, ethyl, n-propyl, isopropyl, butyl,
R′ is a cycloalkyl
n is an integer 1-20
x+y is 3
x is 1or 2
y is 1or 2.

Organosilanes of type (RO)₃Si(CH₂)ₘ—R′, where
R is an alkyl, such as methyl, ethyl, propyl,
m is a number between 0.1-20
R′ is methyl, phenyl, —C₄F₉; OCF₂—CHF—CF₃, C₆F₁₃, —O—CF₂—CHF₂, —NH₂, —N₃, —SCN, —CH═CH₂, —NH—CH₂—CH₂—NH₂, —N—(CH₂—CH₂—NH₂)₂, —OOC(CH₃)C═CH₂, —OCH₂—CH(O)CH₂, —NH—CO—N—CO—(CH₂)₅, —NH—COO—CH₃, —NH—COO—CH₂—CH₃, —NH—(CH₂)₃Si(OR)₃, —S_{X}—(CH₂)₃)Si(OR)₃, —SH—NR′R″R′″ (R′=alkyl, phenyl; R″=alkyl, phenyl; R′″═H, alkyl, phenyl, benzyl, C₂H₄NR″″R′″″ with R″″=A, alkyl and R′″″═H, alkyl).

Preferred silanes are the compounds listed below:

triethoxysilane, octadecyltrimethoxysilane, 3-(trimethoxysilyl)propyl methacrylates, 3-(trimethoxysilyl)propyl acrylates, 3-(trimethoxysilyl)methyl methacrylates, 3-(trimethoxysilyl)methyl acrylates, 3-(trimethoxysilyl)ethyl methacrylates, 3-(trimethoxysilyl)ethyl acrylates, 3-(trimethoxysilyl)pentyl methacrylates, 3-(trimethoxysilyl)pentyl acrylates, 3-(trimethoxysilyl)hexyl methacrylates, 3-(trimethoxysilyl)hexyl acrylates, 3-(trimethoxysilyl)butyl methacrylates, 3-(trimethoxysilyl)butyl acrylates, 3-(trimethoxysilyl)heptyl methacrylates, 3-(trimethoxysilyl)heptyl acrylates, 3-(trimethoxysilyl)octyl methacrylates, 3-(trimethoxysilyl)octyl acrylates, methyltrimethoxysilanes, methyltriethoxysilanes, propyltrimethoxysilanes, propyltriethoxysilanes, isobutyltrimethoxysilanes, isobutyltriethoxysilanes, octyltrimethoxysilanes, octyltriethoxysilanes, hexadecyltrimethoxysilane, phenyltrimethoxysilanes, phenyltriethoxysilanes, tridecafluoro-1,1,2,2-tetrahydrooctyltriethoxysilanes, tetramethoxysilanes, tetraethoxysilane, oligomeric tetraethoxysilanes (Dynasil®40 from Degussa), tetra-n-propoxysilanes, 3-glycidyloxypropyltrimethoxysilane, 3-glycidyloxypropyltriethoxysilanes, 3-methacryloyloxypropyltrimethoxysilanes, vinyltrimethoxysilanes, vinyltriethoxysilanes, 3-mercaptopropyltrimethoxysilanes, 3-aminopropyltriethoxysilanes, 3-aminopropyltrimethoxysilanes, 2-aminoethyl-3-aminopropyltrimethoxysilanes, triamino-functional propyltrimethoxysilanes (Dynasylan® Triamino from Degussa), N-(n-butyl)-3-aminopropyltrimethoxysilanes, 3-aminopropylmethyldiethoxysilanes.

These silanes are added preferably in molar ratios of corundum to silane of 1:1 to 10:1. The amount of organic solvent at deagglomeration is generally 80% to 90% by weight, based on the total amount of corundum and solvent. Solvents which can be used are in principle all organic solvents. Preferred suitability is possessed by C₁-C₄ alcohols, more particularly methanol, ethanol or isopropanol, and also by acetone or tetrahydrofuran.

The deagglomeration by grinding and simultaneous modification with the silane takes place preferably at temperatures from 20° to 150° C., with particular preference at 20° C. to 90° C.

Where the deagglomeration is by grinding the suspension is subsequently separated from the grinding beads.

After the deagglomeration the reaction can be completed by heating the suspension for up to 30 hours. Lastly the solvent is removed by distillation and the residue that remains is dried.

It is also possible to suspend the corundum in the corresponding solvents and to carry out the reaction with the silane after the deagglomeration, in a further step.

The coating compositions of the invention, which are ceramic coatings, Eloxal coatings, but preferably varnishes, further comprise customary and known binders, examples being those described below:

film-forming binders for one-component and multicomponent polymer systems, i.e., in the case of the multicomponent polymer systems, not only the resin but also the hardener may be filled with the particles described under a) and b), and may comprise the aforementioned components known from coating technology:

mono- to polyfunctional acrylates, examples being butyl acrylate, ethylhexyl acrylate, norbornyl acrylate, butanediol diacrylate, hexanediol diacrylate, dipropylene glycol diacrylate, tripropylene glycol diacrylate, trimethylolpropane triacrylate, trimethylolpropane triethoxytriacrylate, pentaerythritol tetraethoxytriacrylate, pentaerythritol tetraethoxytetraacrylate, polyether acrylate, polyether acrylate, polyurethane acrylates, e.g., Craynor® CN 925, CN 981 from Cray Valley Kunstharze GmbH, Ebecryl® EB 1290 from UCB GmbH, Laromer 8987 from BASF AG, Photomer® 6019 or Photomer® 6010 from Cognis, polyester acrylates, e.g., Craynor® CN 292 from Cray Valley Kunstharze GmbH, Laromer® LR 8800 from BASF AG, Ebecryl® EB 800 from UCB GmbH, Photomer® 5429 F and Photomer® 5960 F from Cognis,

epoxy acrylates, e.g., Laromer® EA 81 from BASF AG, Ebecryl® EB 604. from UCB GmbH, Craynor® CN104D80 from Cray Valley Kunstharze GmbH,

dendritic polyester/ether acrylates from Perstorp Speciality Chemicals AG or from Bayer AG,

polyurethane polymers and their precursors in the form of the polyisocyanates, polyols, polyurethane prepolymers, as masked prepolymer and as fully reacted polyurethanes in the form of a melt or solution. Specifically these are:

polyols in the form of polyethers, e.g., polyethylene glycol 400, Voranol® P 400 and Voranol® CP 3055 from Dow Chemicals, polyesters, e.g., Lupraphen® 8107, Lupraphen® 8109 from Elastorgan® GmbH, Desmophen® 670, Desmophen® 1300 from Bayer AG, Oxyester® T 1136 from Degussa AG, alkyd resins, e.g., Worléekyd® C 625 from Worlée Chemie GmbH,

polycarbonates, e.g., Desmophen® C 200, hydroxy-containing polyacrylates, e.g., Desmophen® A 365 from Bayer AG,

polyisocyanates, e.g., Desmodur® N 3300, Desmodur® VL, Desmodur® Z 4470, Desmodur® IL or Desmodur® L 75 from Bayer AG, Vestanat® T 1890 L from Degussa AG, Rodocoat® WT 2102 from Rhodia Syntech GmbH,

polyurethane prepolymers, e.g., Desmodur® E 4280 from Bayer AG, Vestanat® EP-U 423 from Degussa AG,

PMMA and further poly(meth)alkyl acrylates, e.g., Plexisol® P 550 and Degalan® LP 50/01 from Degussa AG.

polyvinyl butyral and other polyvinyl acrylates, e.g., Mowital® B 30 HH from Clariant GmbH,

polyvinyl acetate and its copolymers, e.g., Vinnapas® B 100/20 VLE from Wacker-Chemie GmbH.

For all of the polymers both the aliphatic and the aromatic variants are expressly included. The binder can also be selected such that it is identical with the silane used for functionalization.

Preferably the binders have a molar weight of 100 to 800 g/mol. The amount of binder in the overall coating composition is preferably 80% to 99%, more particularly 90% to 99% by weight.

The coating compositions of the invention may further comprise additional adjuvants typical in coating technology, examples being reactive diluents, solvents and cosolvents, waxes, matting agents, lubricants, defoamers, deaerating agents, flow control agents, thixotropic agents, thickeners, organic and inorganic pigments, fillers, adhesion promoters, corrosion inhibitors, anticorrosion pigments, UV stabilizers, HALS compounds, free-radical scavengers, antistats, wetting agents and dispersants and/or the catalysts, cocatalysts, initiators, free-radical initiators, photoinitiators, photosensitizers, etc. that are necessary depending on the mode of curing. Suitable further adjuvants also include polyethylene glycol and other water retention agents, PE waxes, PTFE waxes, PP waxes, amide waxes, FT paraffins, montan waxes, grafted waxes, natural waxes, macrocrystalline and microcrystalline paraffins, polar polyolefin waxes, sorbitan esters, polyamides, polyolefins, PTFE, wetting agents or silicates.

The intention of the examples which follow is to illustrate the subject matter of the invention in more detail without restricting the possible diversity.

### EXAMPLE 1

A 50%. strength aqueous solution of aluminum chlorohydrate was admixed with 2% of crystallization nuclei from a suspension of ultrafine corundum. After the solution had been homogenized by stirring, drying took place in a rotary evaporator. The solid aluminum chlorohydrate was comminuted in a mortar to give a coarse powder.

The powder was calcined in muffle furnace at 1050° C. The contact time in the hot zone was not more than 5 minutes. This gave a white powder whose grain distribution corresponded to the feed material.

X-ray structural analysis showed that the material is pure-phase α-aluminum oxide. The images of the SEM (scanning electron microscope) micrograph taken showed crystallites in the range 1.0-100 nm. The residual chlorine content was just a few ppm. The nanoparticles were obtained by suspending 150 g of this corundum powder in 110 g of isopropanol and grinding the suspension for 3 hours in a vertical stirred bore mill. Subsequently the solvent was removed by distillation and the wet residue that remained was dried at 100° C. for 20 h.

### EXAMPLE 2

150 g of corundum powder with a grain size in the range 10-50 μm, consisting of crystallites<100 nm, were suspended in 110 g of isopropanol. The suspension was admixed with 40 g of trimethoxyoctylsilane and supplied to a vertical stirred ball mill from Netzsch (type PE 075). The grinding beads used were composed of zirconium oxide (stabilized with yttrium) and had a size of 0.3-0.5 mm. After three hours the suspension was separated from the grinding beads and boiled under reflux for a further 4 h. Subsequently the solvent was removed by distillation and the wet residue that remained was dried in a drying cabinet at 110° C. for a further 20 h.

The images of the SEM (scanning electron microscope) micrograph taken showed the presence of crystallites in the range 10-100 nm.

### EXAMPLE 3

150 g of corundum powder with a grain size in the range 50-200 μm, consisting of crystallites<100 nm, were suspended in 110 g of isopropanol. The suspension was admixed with 40 g of trimethoxyoctylsilane and supplied to a horizontal stirred ball mill. The grinding beads used were composed of zirconium oxide (stabilized with yttrium) and had a size of 0.5-1.0 mm. After six hours the suspension was separated from the grinding beads and boiled under reflux for a further 4 h. Subsequently the solvent was removed by distillation and the wet residue that remained was dried in a drying cabinet at 110° C. for a further 20 h.

The images of the SEM (scanning electron microscope) micrograph taken showed the presence of crystallites in the range 10-100 nm.

### EXAMPLE 4

50 g of corundum powder with a grain size in the range 10-50 μm, consisting of crystallites<100 nm, were suspended in 180 g of isopropanol. The suspension was admixed with 20 g of trimethoxyoctadecylsilane and supplied to a vertical stirred ball mill from Netzsch (type PE 075). The grinding beads used were composed of zirconium oxide (stabilized with yttrium) and had a size of 0.3-0.5 mm. After three hours the suspension was separated from the grinding beads and boiled under reflux for a further 4 h. Subsequently the solvent was removed by distillation and the wet residue that remained was dried in a drying cabinet at 110° C. for a further 20 h.

### EXAMPLE 5

50 g of corundum powder with a grain size in the range 50-200 μm, consisting of crystallites<100 nm, were suspended in 180 g of isopropanol. The suspension was admixed with 20 g of trimethoxyoctadecylsilane and supplied to a horizontal stirred ball mill. The grinding beads used were composed of zirconium oxide (stabilized with yttrium) and had a size of 0.5-1.0 mm. After six hours the suspension was separated from the grinding beads and boiled under reflux for a further 4 h. Subsequently the solvent was removed by distillation and the wet residue that remained was dried in a drying cabinet at 110° C. for a further 20 h.

### EXAMPLE 6

40 g of corundum powder with a grain size in the range 10-50 μm, consisting of crystallites<100 nm, were suspended in 160 g of methanol.

The suspension was admixed with 10 g of 3-(trimethoxysilyl)propyl methacrylate and supplied to a vertical stirred ball mill from Netzsch (type PE 075). The grinding beads used were composed of zirconium oxide (stabilized with yttrium) and had a size of 0.3-0.5 mm. After three hours the suspension was separated from the grinding beads and boiled under reflux for a further 4 h. Subsequently the solvent was removed by distillation and the wet residue that remained was dried in a drying cabinet at 80° C. for a further 20 h.

### EXAMPLE 7

40 g of corundum powder with a grain size in the range 50-100 μm, consisting of crystallites<100 nm, were suspended in 160 g of methanol. The suspension was admixed with 10 g of 3-(trimethoxysilyl)propyl methacrylate and supplied to a horizontal stirred ball mill. The grinding beads used were composed of zirconium oxide (stabilized with yttrium) and had a size of 0.5-1.0 mm. After six hours the suspension was separated from the grinding beads and boiled under reflux for a further 4 h. Subsequently the solvent was removed by distillation and the wet residue that remained was dried in a drying cabinet at 80° C. for a further 20 h.

### USE EXAMPLES

Non-surface-modified nanocorundum from example 1 and the various surface-modified corundum samples from examples 2-7 were tested in different varnish systems for their abrasion resistance, gloss, and scratch resistance. The tests took place in an aqueous acrylic varnish system, a 2-component polyurethane varnish system, and a 100% UV varnish system.

I. Aqueous Acrylic Varnish System

Gloss

The gloss of the varnish films on the glass plates were determined using the micro-gloss from BYK-Gardner, at an angle of 60°.

| | Gloss |
|---|---|
| No additive | 115 |
| 1% nanocorundum | 107 |
| 2% nanocorundum | 99 |
| 4% nanocorundum | 81 |
| 6% nanocorundum | 75 |

Pencil Hardness

The hardness of the varnish films on the glass plates was determined by means of the Wolff-Wilborn pencil hardness, in accordance with the scale below.

Soft
6B
5B
4B
3B
2B
B
HB
F
H
2H
3H
4H
5H
6H
7H
8H
9H
Hard

| | Pencil hardness |
|---|---|
| No additive | 2B |
| 1% nanocorundum | B |
| 2% nanocorundum | B |
| 4% nanocorundum | HB |
| 6% nanocorundum | HB |

Taber Test—Abrasion

An air gun was used to spray the varnish samples onto special glass plates. Using the Taber Abraser, after different rotations, the haze was measured using the Haze-Gard Plus, and the change in haze was calculated.

| | after 10 rot. | after 20 rot. | after 50 rot. |
|---|---|---|---|
| No additive | 13 | 6 | 8 |
| 1% nanocorundum | 13 | 7 | 10 |
| 2% nanocorundum | 11 | 5 | 8 |
| 4% nanocorundum | 2 | 1 | 1 |
| 6% nanocorundum | 2 | 0 | 0 |

II. 2-Component Polyurethane Varnish

The samples from examples 2-7 were dispersed into the 1st component of a 2K PU varnish system.

Abrasion

Using an air gun the varnish samples were sprayed onto special glass plates. Using the Taber Abraser, after different rotations, the masses were determined and hence the abrasion was calculated.

| | after 10 | after 20 | after 50 | after 100 |
|---|---|---|---|---|
| Masses [mg] | rotations | rotations | rotations | rotations |
| 4% corundum/ex. 6 or 7 | 0.0 | 0.5 | 1.4 | 3.3 |
| Varnish without additives | 0.1 | 0.4 | 1.2 | 3.7 |
| 3% NANOBYK-3610 | 0.6 | 0.8 | 1.7 | 3.8 |
| 4% corundum/ex. 2 or 3 | 0.0 | 0.5 | 1.1 | 3.8 |
| 4% corundum/ex. 4 or 5 | 0.0 | 0.5 | 1.7 | 4.1 |
| 10% corundum/ex. 2 or 3 | 0.3 | 0.8 | 2.2 | 4.8 |

Nanobyk is a dispersion of surface-modified nanoaluminum in methoxypropylacetate solvent for improving the scratch resistance.

Gloss

The gloss of the varnish films on the glass plates were determined using the micro-gloss from BYK-Gardner, at an angle of 60°. (Wet-film thickness 60 μm)

| | Gloss/60^{°} |
|---|---|
| No additive | 145 |
| 4% nanocorundum/ex. 4 or 5 | 132 |
| 4% nanocorundum/ex. 6 or 7 | 131 |
| 4% nanocorundum/ex. 2 or 3 | 126 |
| 10% nanocorundum/ex. 2 or 3 | 120 |
| 6% nanocorundum/ex. 2 or 4 | 110 |
| 3% NANOBYK-3610 | 94 |

Pencil Hardness

The hardness of the varnish films on the glass plates was determined by means of the Wolff-Wilborn pencil hardness.

| | Hardness |
|---|---|
| No additive | F |
| 10% nanocorundum/ex. 2 or 3 | F |
| 6% nanocorundum/ex. 2 or 3 | F |
| 4% nanocorundum/ex. 4 or 5 | F-H |
| 3% NANOBYK-3610 | H |
| 4% nanocorundum/ex. 2 or 3 | H |

III. UV Varnish

The samples from examples 1 to 7 were dispersed into the 1st component of a 2K PU varnish system.

Abrasion

Using an air gun the varnish samples were sprayed onto special glass plates. Using the Taber Abraser, after different rotations, the masses were determined and hence the abrasion was calculated.

| Mass [mg] | 50 rotations | 100 rotations | 200 rotations |
|---|---|---|---|
| Corundum/ex. 6 or 7 | 1.1 | 2.4 | 6.7 |
| 2% NANOBYK-3601 | 1.2 | 2.8 | 7.2 |
| Corundum/ex. 1 | 0.4 | 2.1 | 8.0 |
| Corundum/ex. 2 or 3 | 0.8 | 2.6 | 8.2 |
| Corundum/ex. 4 or 5 | 0.9 | 2.8 | 8.6 |
| No additive | 1.0 | 3.5 | 11.7 |

Gloss

The gloss of the varnish films on the glass plates were determined using the micro-gloss from BYK-Gardner, at an angle of 60°. (Wet film thickness 60 μm)

| | Gloss/60^{°} |
|---|---|
| Nanocorundum/ex. 6 or 7 | 136 |
| No additive | 135 |
| 2% NANOBYK-3601 | 132 |
| Nanocorundum/ex. 1 | 122 |
| Nanocorundum/ex. 2 or 3 | 121 |
| Nanocorundum/ex. 4 or 5 | 99 |

Pencil Hardness

The hardness of the varnish films on the glass plates was determined by means of the Wolff-Wilborn pencil hardness.

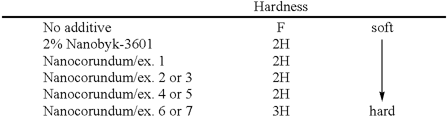

Haze of the Varnish Films

Measurement of the haze with the Haze-Gard Plus on the basis of the varnish films knife-coated onto the glass plates (wet film thickness 60 μm).

| | Resin/haze |
|---|---|
| No additive | 0.4 |
| Nanocorundum/ex. 6 or 7 | 1.1 |
| NANOBYK-3601 | 2.2 |
| Nanocorundum/ex. 4 or 5 | 9.4 |
| Nanocorundum/ex. 2 or 3 | 14.1 |
| Nanocorundum/ex. 1 | 17.0 |

1. A coating composition comprising silane-modified nanoparticles and an organic binder and optionally, adjuvants, wherein the silane-modified nanoparticles are formed by deagglomeration of nanoparticle-comprising agglomerates in the presence of an organic solvent and simultaneous treatment with a silane.

2. A varnish comprising a coating composition as claimed in claim 1.

3. The coating composition as claimed in claim 1, wherein the deagglomeration of nanoparticle-comprising agglomerates is achieved by grinding or exposure to ultrasound.

4. The coating composition as claimed in claim 1, wherein the deagglomeration of nanoparticle-comprising agglomerates is achieved by grinding and simultaneous treatment with a silane.

5. The coating composition as claimed in claim 1, wherein the deagglomeration of nanoparticle-comprising agglomerates is achieved by grinding and simultaneous treatment with a lower alcohol.

6. The coating composition as claimed in claim 1, wherein the deagglomeration of nanoparticle-comprising agglomerates is achieved by grinding and simultaneous treatment with a silane in a lower alcohol at temperatures from 20 to 150° C.
